(19) United States
(12) Patent Application Publication
(10) Pub. No.: US 2004/0221027 A1
(43) Pub. Date: Nov. 4, 2004

(54) Network infrastructure circuit management system and method

(76) Inventor: Scott T. Parrott, San Clemente, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/427,517

(22) Filed: May 1, 2003

(51) Int. Cl. G06F 15/173

(52) U.S. Cl. 709/223

(57) ABSTRACT

A method and system for managing network infrastructure circuits is provided. The method includes selecting a primary circuit having terminations assigned to the end points of the overall network connection and interconnecting the primary circuit to at least one secondary circuit according to predetermined linkage rules. A circuit manage system is configured to cross correlate the primary circuit and the at least one secondary circuit according to linkage relationships stored in a management database. In another embodiment, a computer readable media including computer executable instructions for maintaining circuit identifiers, managing endpoint location information and tracking circuit linkage relationships is provided.

### BACKGROUND OF THE INVENTION

1. Field of the Invention

The present invention relates to the field of communication networks. More particularly, the present invention relates to a system and method for managing network infrastructure circuits.

2. State of the Art

A communication circuit comprises a discrete path between two or more points along which a signal may be carried. The signal may be carried along a physical path comprising one or more cables, or alternatively, along a wireless path. The communication circuit may further comprise intermediate switching points to route the signal among the two or more points in the circuit. A communication network may comprise a series of points or nodes interconnected by one or more communication circuits. As used herein, a communication network may comprise any suitable communications system, such as a telephone circuit, a cellular telephone system, a cable television system, a satellite link, a local area network (hereinafter, “LAN”), a wide area network (hereinafter, “WAN”), the Internet, or any other appropriate analog or digital transmission system. A communication network may be characterized by the type of data transmission employed (e.g., voice, data, or both), by access to the network (e.g., public or private), by the usual nature of the network's connections (e.g., dial-up (switched), dedicated (non-switched), or virtual), and by the type of physical links employed (e.g., optical fiber, coaxial cable, or unshielded twisted pair).

Large communication networks are typically created when one or more Inter-eXchange Carrier (hereinafter, “IXC”), Local eXchange Carrier (hereinafter, “LEC”), or private LAN owner enter into sharing and exchange arrangements. For example, FIG. 1 illustrates a network 8 comprising a first LAN 10 and a second LAN 12 interconnected via a plurality of communication circuit segments 14, 16, 18. The first LAN 10 and second LAN 12 may be physically located relative to one another in different parts of a city, state, country or region and may each comprise a substantial internal network infrastructure owned by a user. Alternatively, at least a portion of the first LAN 10 and the second LAN 12 may be leased from LEC A and LEC B. LEC A and LEC B may each represent a local telecommunications company. The first LAN 10 may connect to an IXC's central office (hereinafter, “CO”) 20 located at one end of the overall connection (shown as the A end) via a circuit segment 14 owned by LEC A. Likewise, the second LAN 12 may connect to the IXC's CO 22 located at the other end of the overall connection (shown as the Z end) via a circuit segment 18 owned by LEC B. Circuit segments 14 and 18 may each be leased or otherwise procured by the IXC for termination in the respective geographic locations of the first LAN 10 and the second LAN 12. The IXC may provide the first LAN 10 and the second LAN 12 with Internet backbone connectivity via a circuit segment 1 6 connecting a point-of-presence (hereinafter, “POP”) at the CO 20 located at the A end and a POP located at the CO 22 at the Z end.

The end-to-end circuit connection of the network 8 comprises overall endpoints at the first LAN 10 and the second LAN 12 interconnected via physical links or segments comprising communication circuits 14, 16 and 18. Further, each circuit segment 14, 16, 18 comprises endpoints or nodes. Thus, LEC A's circuit segment 14 comprises endpoints at the first LAN 10 and the CO 20 at the A end; LEC B's circuit segment 18 comprises endpoints at the second LAN 12 and the CO 22 at the Z end; and the IXC circuit segment 16 comprises endpoints at the CO 20 at the A end and the CO at the Z end. As the communication network 8 expands, it becomes more complex. Thus, it is increasingly difficult for a user to manage information relative to the network's 8 infrastructure assets and inventories as the relevant information is exchanged among the shared endpoints or nodes of each of the circuit segments 14, 16, 18 as well as between the circuit segments 14, 16, 18 and communication equipment (not shown). The communication equipment may include, by way of example only and not by limitation, asynchronous transfer mode (hereinafter, “ATM”) switch ports, frame relay switch ports, router interfaces, and private branch exchange (hereinafter, “PBX”) ports.

Historically, managing network infrastructure assets and inventories has been approached from either a billing administration perspective or an engineering perspective. Typically, billing administration perspectives and engineering perspectives have had differing, and sometimes opposing, objectives. Communication networks influenced by a billing administration perspective are typically designed around charges associated with individual circuits with a focus on cost accounting. Such networks may provide some information in the form of line item billing entities with no relational information between the line items. For example, the network management scheme may provide a plurality of line items, such as circuit identifiers, with charges associated with each line item, but without a relationship between each of the line items sufficient enough to allow a network designer or manager to analyze whether any of the plurality of line items are part of the same end-to-end circuit connection. Further, there may be no way to correlate a bill for toll free service with circuit charges associated with its endpoints or terminations. Thus, there may be no way of quickly ascertaining how much a carrier-provided service may actually be costing the user. Therefore, it is difficult for a user to perform true consumption management because the user lacks information regarding the effect of specific changes or disconnects on other services or circuits within the network's infrastructure.

Communication networks influenced by an engineering perspective are less concerned about billing and more concerned with factors such as capacity planning, management and support. However, engineering solutions are typically complicated and tend to cannibalize numerous hours of engineering resources to maintain the management database. Further, engineering solutions typically exhibit ineffective billing and reporting capabilities. Thus, prior attempts to manage network infrastructure circuits fail to balance utility versus content and are unsuccessful in maximizing data integrity and minimizing data entry time. Moreover, conventional asset management solutions typically employ a generic approach to quantifying what assets are available, how many assets are available, and where the assets are located. Thus, conventional asset management solutions typically require massive customization that results in large investments of time and money. Even with such investment, communication network designers typically fail to understand both the billing administration and engineering perspectives necessary to design a solution incorporating both.

Therefore, there is a need for a circuit management system that provides complete information about an end-to-end circuit so that each individual circuit segment's role and relationship to interconnected circuit segments is known for the entire end-to-end connection.

### BRIEF SUMMARY OF THE INVENTION

A method and apparatus are described for managing network infrastructure circuits. The method includes selecting a primary circuit having terminations assigned to the endpoints of the overall network connection and interconnecting the primary circuit to at least one secondary circuit according to predetermined linkage rules.

In another embodiment of the present invention, a circuit management system is configured to cross-correlate the primary circuit and the at least one secondary circuit according to linkage relationships stored in a management database.

In yet another embodiment of the present invention, a computer readable media including computer executable instructions for maintaining circuit identifiers, managing endpoint location information and tracking circuit linkage relationships is provided.

Other features and advantages of the present invention will become apparent to those of skill in the art through a consideration of the ensuing description, the accompanying drawings, and the appended claims.

### BRIEF DESCRIPTION OF THE SEVERAL VIEWS OF THE DRAWINGS

In the drawings, which illustrate what is currently considered to be the best mode for carrying out the invention:

FIG. 1 is a schematic representation of a network comprising a plurality of circuit segments interconnecting two overall network endpoints;

FIG. 2 is a block diagram of a circuit management system, in accordance with an embodiment of the present invention;

FIG. 3 is a schematic of a circuit management linkage, in accordance with an embodiment of the present invention; and

FIGS. 4 through 8 are schematic representations of networks circuit segments interconnected according to linkage rules, in accordance with embodiments of the present invention.

### DETAILED DESCRIPTION OF THE INVENTION

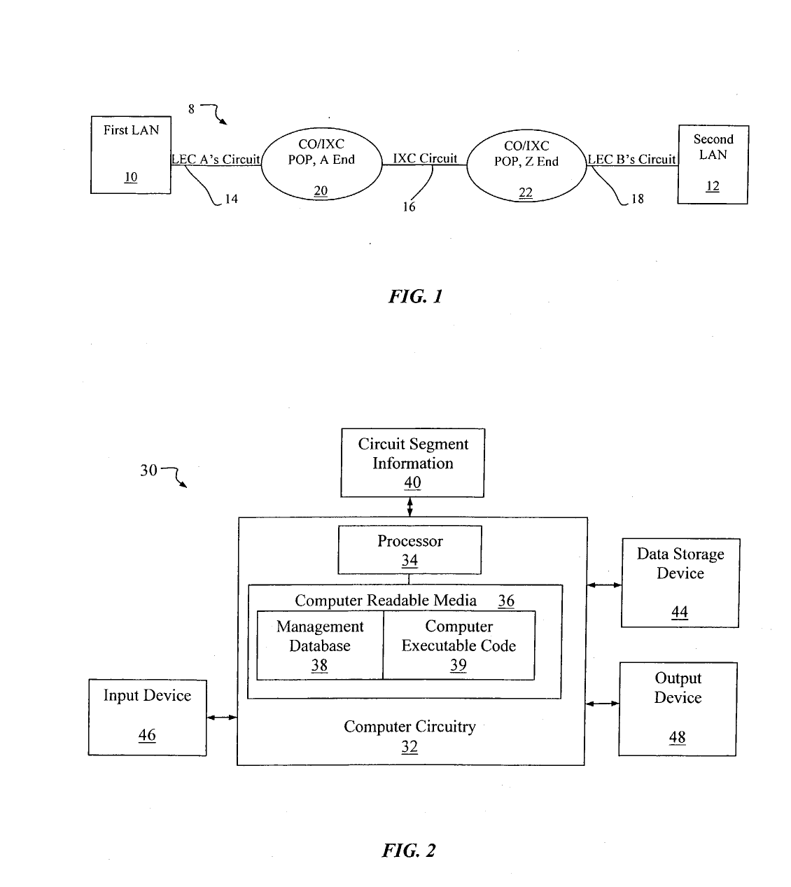

FIG. 2 illustrates, according to one embodiment of the present invention, a block diagram of a circuit management system 30 configured to inventory and manage a user's network infrastructure. The circuit management system 30 comprises computer circuitry 32 electrically connectable to circuit segment information 40 provided by a communication network (not shown), such as the communication network 8 shown in FIG. 1. The computer circuitry 32 is configured to perform computer functions such as executing software to perform desired calculations and tasks. The computer circuitry 32 may include a processor 34 and a computer readable medium 36. The computer readable medium 36 may comprise a management database 38 and computer executable code 39 for performing circuit management operations, as described in more detail below.

The circuit management system 30 may further comprise an external data storage device 44, an input device 46 and an output device 48. The external data storage device 44 may include, by way of example only, drives that accept hard and floppy discs, tape cassettes, CD-ROM or DVD-ROM. The input device may include by way of example only, an Internet or other network connection, a mouse, a keypad or any device that allows an operator to enter data into the computer circuitry 32. The output device 48 may include, by way of example only, a printer or a video display device.

The circuit segment information 40 is configured to provide selected billing and physical link information for a plurality of circuit segments and/or communication equipment. The billing and physical link information may include, by way of example only and not by limitation, endpoint geographical location information, endpoint demark information, equipment identification, circuit identification, order information, trunk group information, and toll free and dial plan information. Alternatively, at least a portion of the billing and physical link information may be stored in the management database. As used herein, demark information refers to information specifying a physical location, such as building, floor or room identification information, of a communication circuit or communication equipment.

Referring to FIGS. 1 and 2, in one embodiment of the present invention, the circuit management system 30 is configured to track the interconnected communication paths or circuit segments 14, 16, 18 leased from telecommunication providers (i.e., LEC A, LEC B and IXC) that bridge together the shared nodal endpoints (i.e., at 20 and 22) to form an end-to-end network connection between the overall endpoints (i.e., at 10 and 12) of the network 8. The circuit management system 30 is configured to create “circuit linkage” relationships between the circuit segments 14, 16, 18 so that any one of the individual circuit segments may be cross-correlated to respective interconnected circuit segments in the overall circuit connection. The circuit linkage relationships manage the complex, horizontal and vertical relationships between the circuit segments 14, 16, 18 as well as between the circuit segments 14, 16, 18 and any terminating communication equipment (not shown) connected thereto.

In one embodiment of the present invention, three basic circuit linkage relationships, referred to herein as “peer,” “parent/child” and “parallel,” are used by the circuit management system 30 for segmentation and hierarchical circuit management. A peer circuit linkage relationship comprises a horizontal linkage between circuit segments 14, 16, 18 of equal size and circuit type (e.g., twisted pair, DS0, FT1, T1, T3, E1, E3, OCx, etc.) which connect on the same hierarchical level or plane. A parent/child circuit linkage relationship comprises a vertical linkage between two circuit segments 14, 16, 18 wherein a parent circuit is hierarchically superior (i.e., at a circuit layer or level above) to a child circuit.

A parallel circuit linkage relationship comprises a linkage between circuit segments 14, 16, 18 of equal size, of equal circuit type, and having the same endpoints that are connected in parallel to form a larger circuit with bandwidth equal to the sum of the bandwidth of the individual links. Although parallel circuit linkage relationships may extend to other circuit types, a parallel circuit linkage relationship preferably creates a relationship between inverse multiplexed access (hereinafter, “IMA”) T1 circuits and preserves the relationships between each circuit in the bundle of IMA T1 circuits wherein the circuit bandwidths are combined to serve as a larger access circuit to terminate one or more permanent virtual circuit (hereinafter, “PVC” circuit) or channelized sub-rate circuit.

An equipment linkage relationship is an additional linkage relationship unlike the three basic linkage relationships described above. The equipment linkage relationship is used by the circuit management system 30 to link a primary circuit segment (described below) to telecommunications equipment such as an ATM switch port, a frame relay switch port, a router interface, or a PBX port.

According to one embodiment of the present invention, the circuit and/or equipment linkage relationships described above manage the complex relationships between the circuit segments 14, 16, 18, and/or any terminating communication equipment connected thereto, through linkage rules that govern the use of circuit types (e.g., twisted pair, DS0, FT1, T1, T3, E1, E3, OCx, etc.) and linkage permissions allowed for each circuit type.

Each circuit type may also be characterized according to a topological category. As used herein, a circuit topology defines a logical route of a circuit that specifies how information traverses the circuit's endpoints. For example, a circuit may be categorized as having a ring circuit topology or a point-to-point circuit topology. Although not discussed herein, it should be understood that the scope of the present invention includes characterizing circuits and circuit types according to other known circuit topologies, such as a star topology wherein nodes are connected to a central hub.

A ring circuit topology comprises a configuration of diverse, concentric fiber rings connecting two or more distinct endpoint locations or nodes wherein the last node is connected to the first node to form a loop. As used herein, the term “circuit segment” does not refer to the connections between the distinct endpoint locations or nodes in a ring circuit. To form an overall end-to-end circuit connection, a ring circuit may be configured to carry smaller point-to-point circuit segments (described below) in a parent/child linkage relationship. A ring circuit may be configured to have a peer linkage relationship with other ring circuits of equal size. A ring circuit may also be configured to have a parent/child linkage relationship with a point-to-point circuit segment or other ring circuits of different sizes.

A point-to-point circuit topology comprises a connection between two distinct endpoint locations using a single route. Point-to-point circuit topologies may comprise a plurality of circuit segments comprising analog, digital, optical (e.g., OCx), or virtual (e.g., PVC) links. Point-to-point circuit topologies may utilize peer and parallel circuit linkages to create relationships with other point-to-point circuits of equal size as well as parent/child circuit linkages to create relationships to hierarchically superior or inferior point-to-point circuits or ring circuits.

To classify a point-to-point circuit segment's role in an overall circuit connection, each point-to-point circuit segment may be classified as a “primary” or “secondary” circuit segment. A primary classification is assigned to classify circuit segments that control the overall circuit or carry child circuits or channel services. Thus, primary circuit segments are master circuit segments with respect to the other linked circuit segments that make up the overall end-to-end circuit connection. A primary circuit segment controls the service or channel services utilized by the overall end-to-end circuit and may comprise an IXC circuit segment or an LEC circuit segment when only a local circuit is required for the connection. Primary circuit segment endpoints are defined as the same as the overall end-to-end circuit connection endpoints even though the overall circuit connection endpoints may differ from the actual physical endpoints of the primary circuit segment.

Primary circuit segments may be channelized (i.e., partitioned into a fixed number of sub-rate time slots or channels) or non-channelized (i.e., having only one partition per circuit segment) depending on the linkage rules selected for the circuit type of the primary circuit segment. Examples of primary circuit segments include, but are not limited to: a channelized IXC T1 circuit for providing voice connectivity for a site location; a point-to-point data circuit; an ATM or frame relay T3 access circuit; a point-to-point fractional T1 circuit; a PVC circuit between two user locations; an integrated service digital network (hereinafter, “ISDN”) basic rate interface (hereinafter, “BRI”) or digital subscriber line (hereinafter, “DSL); or a 56 KB data circuit.

According to another embodiment of the present invention, primary circuit segments are further classified according to a selected service property. Thus, the circuit management system 30 shown in FIG. 1 may be configured to group circuit segments into service categories. A service category of a primary point-to-point circuit segment may be selected from the group comprising a data circuit, a voice circuit, a video circuit, an access circuit, or any other circuit related to a service property of a communication network.

A data circuit is configured to transport data services via a non-channelized facility across its circuit segment. Examples of data circuits include, but are not limited to: a 56 KB, DSL or ISDN line over a twisted pair; a PVC; or a non-channelized WAN/MAN OCx or DSx circuit that transports data from one site location to another. A voice circuit is configured to provide voice communication across its circuit segment and is preferably restricted to channels on a T1 circuit having a bandwidth of 64 KB allotted thereto. A video circuit preferably comprises a T1 or fractional T1 circuit configured to provide video or videoconferencing connectivity.

An access circuit is configured to terminate the traffic of one or more individual child or peer circuits and preferably traverses between a CO/IXC and a user endpoint location. However, an access circuit may be used as tie trunks connecting two user endpoint locations. For example, tie trunks for voice call re-routing between a plurality of PBXs. An access circuit may be configured to be channelized or non-channelized. Examples of access circuits include, but are not limited to: non-channelized and channelized OCx and DSx circuits connecting a CO/IXC and a site location used to terminate PVCs or other sub-rate circuits; site-to-site channelized or non-channelized tie trunks; and T1 circuits that terminate channel services and/or fractional T1 circuits.

A secondary classification is assigned to circuit segments that terminate the payload or traffic of a single primary circuit segment. Secondary circuits may not be channelized and are configured to provide unaltered transport for a primary circuit segment's payload to and from the secondary circuit's endpoints. Secondary circuits preferably have peer linkage relationships only with a primary circuit segment and their endpoints are defined by their physical endpoints. Examples of secondary circuit segments include, but are not limited to: a point-to-point T1 circuit provisioned on a ring at a network hub site to terminate an IXC circuit; or any LEC circuit segment that is used to terminate an IXC circuit. Note, however, that whether a user decides to track an LEC circuit used to terminate an IXC circuit will depend on internal provisioning management fundamentals.

In a preferred embodiment, local loop or LEC circuits that are procured or leased by the IXC are not tracked because the LEC circuit identifiers (hereinafter, “IDs”) are often not received from the IXC. Also, when the LEC circuit fDs are inserted into the circuit database, it often creates confusion as to whether the user of the LEC actually supports the local circuit. Further, entering the entire circuit including all segments and linkages may be time consuming and too much information is often worse than not enough information. The circuit management system, according to the preferred embodiment, is centered on tracking only the circuit segments that the user receives a bill for and ultimately supports. Thus, it may be advantageous to track the minimum amount of information necessary to assist with capacity planning and system management as well as to support the circuit, its connection, and the cost associated with it.

According to another embodiment of the present invention, the circuit management system 30 shown in FIG. 2 is configured for nodal management of endpoints wherein each terminating location of a circuit is tracked and managed. Nodal management of endpoints provides information about an overall circuit connection as well as each individual circuit connection it comprises. Preferably, an overall end-to-end circuit connection comprises one primary circuit segment having the same endpoint nodes and being on the same hierarchical level as the overall circuit. The overall end-to-end circuit may further comprise at least one parent primary circuit segment and at least one peer secondary circuit segment. Thus, each segment in the end-to-end circuit connection will either be the dominant segment (i.e., primary), or a support segment (i.e., secondary). The primary circuit segment utilizes the same endpoints as the overall connection because everything stems off the primary circuit segment. Thus, all circuit linkage relationships relate back to the primary circuit segment including circuit linkage relationships between all secondary segments and to any equipment linkages.

The primary circuit segment also utilizes the same endpoints as the overall end-to-end circuit connection to provide a modular, incremental approach to circuit management. By having the primary circuit segment assume the endpoints of the overall connection, its presence in the overall circuit provides sufficient information to support and manage the end-to-end circuit without any knowledge of secondary circuit segments or linkages. In contrast to primary circuit segments, secondary circuit segments reflect their actual physical endpoint locations and preferably do not link to demark information. Thus, data entry time is minimized through the establishment of primary and secondary circuit segments wherein circuit inventories in a network infrastructure may be built in stages. Each stage of the network infrastructure acts like a branch on a tree in that it expands the breadth of information and linkage relationships of the overall connection. Thus, users may start with a basic inventory of basic information and slowly build upon it by adding circuit linkage relationships and communication devices, defining endpoints, building relationships to trunk groups, setting up billing allocations, and tying circuits to service request information as more information is gathered and/or becomes available.

As discussed above, a ring circuit is a complete circuit and has two or more endpoint locations. Preferably, ring circuits do not directly participate in an overall point-to-point connection. Rather, a ring circuit's point-to-point child circuit segments are utilized as primary or secondary circuit segments between any two of the ring circuit's endpoint nodes. To track specific termination information, the primary circuit segment may contain, at one or both ends, demark information at the user or non-carrier locations.

All physical locations that are involved in a point-to-point circuit connection may be inventoried and uniquely categorized by the combination of their city, state (if applicable), street, and site type. A portion of these locations, representing user-owned locations, may also comprise at least one demark identified to provide additional detail about physical termination locations of specific circuits. Any non-carrier location may utilize demark information. However, demark information may not be required for carrier locations including LEC COs and IXC POPs.

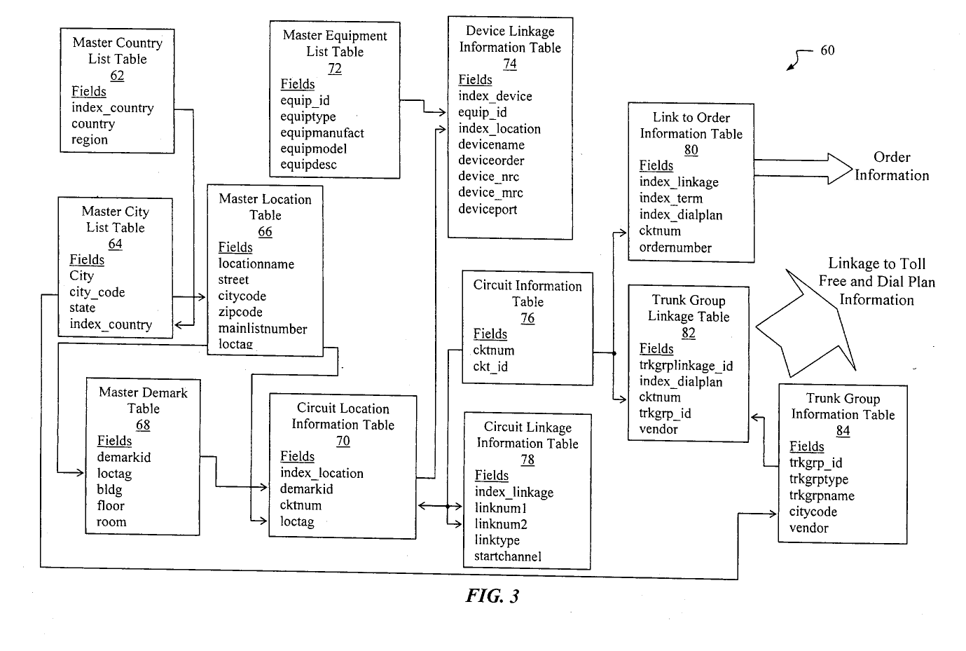

FIG. 3 illustrates a schematic of a circuit management linkage 60 according to the present invention. The circuit management linkage 60 is configured to manage relationships between interconnected circuit segments (not shown) of an overall end-to-end circuit connection (not shown). The circuit management linkage 60 is also configured to manage relationships between the circuit segments and any terminating communication equipment (not shown) connected thereto. The circuit management linkage 60 may be in the form of computer executable code, such as the computer executable code 39 shown in FIG. 2. The circuit management linkage 60 is configured to manage selected billing and physical link information, including demark information, for the circuit segments and/or communication equipment. At least a portion of the billing and physical link information may be stored in an electronic database, such as the management database 38 shown in FIG. 2.

The circuit management linkage 60 comprises a master country list table 62, a master city list table 64, a master location table 66, a master demark table 68, a circuit location information table 70, a master equipment list table 72, a device linkage information table 74, a circuit information table 76, a circuit linkage information table 78, a link to order information table 80, a trunk group linkage table 82, and a trunk group information table 84. Each table 62, 64, 66, 68, 70, 72, 74, 76, 78, 80, 82, and 84 comprise the data fields necessary to track and manage its respective billing and/or physical link information.

The circuit information table 76 is configured to maintain all individual circuit information, such as circuit identifiers. The master country list table 62, master city list table 64, master location table 66, and master demark table 68 are configured to manage endpoint location information including first level location information (e.g., physical address information) and second level location information (e.g., demark information). The master equipment list table 72 and device linkage information table 74 are configured to track equipment linkages to primary circuits at their endpoint locations. The circuit location information table 70 maintains pointers to location and demarcation information for each qualifying circuit endpoint. The circuit linkage information table 78 is configured to track all circuit linkages between individual circuits, including peer linkages, parent/child linkages and parallel (i.e., IMA) linkages.

The trunk group linkage table 82 and trunk group information table 84 are configured, for circuits that are part of dedicated voice trunk groups, to map circuits to the trunk group and map the trunk group to toll free termination or dial plan ranges. The link to order information table 80 is configured to link installed circuits back to the orders associated with them. Thus, the link to order information table 80 is configured to interface with an order information element and the trunk group linkage table 82 and trunk group linkage table 84 are configured to link to toll free and dial plan information elements. Thus, the circuit management linkage 60 tracks and manages relative billing and physical link information required for billing administrators and system managers.

Thus, in a general sense, valuable information about an end-to-end circuit may be tracked and managed through horizontal and vertical linkage relationships between circuit segments so that each individual circuit segment's role and relationship to its peers, parents and children are known. Further, data entry time is minimized by allowing circuit inventories to be built modularly or in stages. A primary segment of an overall circuit provides information for billing and support as it has the same endpoints as the overall circuit and controls the service and bandwidth of the connection. Also, Trunk groups linked to dedicated dial plan ranges or toll free routing terminations allows the voice and data network infrastructure to be bridged together and billing reports may show detailed consumption usage by location, demark, overall circuit, or billing allocation.

As discussed above, circuit and/or equipment linkages manage the complex relationships between interconnected circuit segments, and/or any terminating communication equipment connected thereto, through linkage rules that govern the existence of circuit types and linkage permissions allowed for each circuit type. TABLE 1 below describes a set of linkage rules for each of a plurality of circuit types, according to one embodiment of the present invention. TABLE 1 also provides a description and behavior summary for each of the plurality of circuit types listed. The linkage rules for each circuit type may be in the form of computer executable code, such as the computer executable code 39 shown in FIG. 2.

TABLE 1
Circuit Type Linkage Rules

| Type | | |
|---|---|---|
| Category | Description and Behavior | Linkage Rules |
| Twisted Pair | Point-to-point circuit | No peer linkages |
| Circuits | Supports two wire twisted pair | allowed |
| | data circuits | No parent/child linkages |
| | Supports multiple bandwidth | allowed |
| | configurations | Equipment linkages |
| | 56 K circuits over twisted pair (2 | allowed |
| | wire) | No IMA linkages |
| | Basic Rate ISDN (BRI) of 128 KB | allowed |
| | bandwidth maximum and D | |
| | channel for communication | |
| | Even though ISDN BRI circuits | |
| | may support compressed digital | |
| | voice on one of its two B channels, | |
| | the circuit is still considered to be | |
| | exclusively data | |
| | DSL circuits may have different | |
| | upstream and downstream | |
| | bandwidth throttles | |
| DS0 Circuits | Point-to-point circuit | No peer linkages |
| | 64 KB voice or data channels riding | allowed |
| | a T1 or E1 circuit | May be a child in a |
| | Includes voice channels for | parent/child linkage to: |
| | terminating telephone calls | T1 circuits |
| | Includes D channels on 24 channel | May not be a parent in a |
| | of ISDN PRI circuit | parent/child linkage |
| | Includes data channels that are | No equipment linkages |
| | used by carriers for complex | allowed |
| | routing | No IMA linkages |
| | | allowed |
| FT1 Circuits | Point-to-point circuit | No peer linkages |
| (or Fractional T1) | Fractional DS1 circuits may have | allowed |
| | bandwidth = n × 64 KB, where n = 1 | May be a child in a |
| | to 24 | parent/child linkage to: |
| | FT1 circuits ride parent DS1 | T1 circuits |
| | circuits and may occupy 1 to many | May not be a parent in a |
| | channels on a T1 or E1 | parent/child linkage |
| | FT1 circuits may not be | Equipment linkages |
| | channelized | allowed |
| | | No IMA linkages |
| | | allowed |
| T1 Circuits | Point-to-point circuit | Peer linkages allowed to |
| | Most commonly used digital line | other T1 or E1 circuits |
| | in the U.S., Canada and Japan | May be a parent in a |
| | T1 circuit bandwidth is 1.544 MB | parent/child linkage to: |
| | (non-channelized) and 1.536 MB | DS0 circuits |
| | (channelized) | FT1 circuits |
| | T1 circuits may be channelized to | May be a child in a |
| | carry 24 sub-rate DS0 channel | parent/child linkage to: |
| | circuits or a combination of DS0 | T3 circuits |
| | channel circuits and FT1 circuits | OC3 circuits |
| | T1 circuits may ride on a parent | Equipment linkages |
| | ring and point to point DS3 and | allowed |
| | OCx circuits (rare) | IMA linkages allowed |
| | T1 circuits typically ride a parent | |
| | T3 that may in turn ride a parent | |
| | OCx circuit | |
| E1 Circuits | Point-to-point circuit | Peer linkages allowed to |
| | European Digital Transmission | other T1 or E1 circuits |
| | format used by many in Europe | May be a parent in a |
| | and Canada | parent/child linkage to: |
| | E1 circuit bandwidth is 2.048 MB | DS0 circuits |
| | E1 circuits may be channelized to | FT1 circuits |
| | carry 32 sub-rate DS0 channel | May be a child in a |
| | circuits or a combination of DS0 | parent/child linkage to: |
| | channel circuits and FT1 circuits | E3 circuits |
| | | Equipment linkages |
| | | allowed |
| | | IMA linkages allowed |
| T3 Circuits | Point-to-point circuit | Peer linkages allowed to |
| | Commonly used by Internet | other T3 or E3 circuits |
| | Service Providers (ISPs) and for | May be a parent in a |
| | backbone intranet connections | parent/child linkage to: |
| | T3 bandwidth is 44.736 MB | T1 circuits |
| | T3 circuits may ride parent OCx | May be a child in a |
| | ring (where x = 3, 12, 48, etc.) and | parent/child linkage to: |
| | occupy a single slot on an OCx | OCx ring or |
| | ring circuit | point to point |
| | T3 may be channelized to carry 28 | circuits |
| | T1 circuits | Equipment linkages |
| | | allowed |
| | | No IMA linkages |
| | | allowed |
| E3 Circuits | Point-to-point circuit | Peer linkages allowed to |
| | Not a commonly used circuit, but | other T3 or E3 circuits |
| | is still used sparingly in Europe | May be a parent in a |
| | E3 bandwidth is 34.368 MB | parent/child linkage to: |
| | E3 may be channelized to carry 16 | E1 circuits |
| | E1 circuits | May not be a child in a |
| | | parent/child linkage |
| | | Equipment linkages |
| | | allowed |
| | | IMA linkages allowed |
| OCx Circuits | Point-to-point or ring circuit | Point-to-point OC3 peer |
| Where x = 3, | OCx circuits ride fiber optic cable | linkages allowed |
| 12, 48, 96, 192 | and may ride x number of | between point to point |
| | contiguous channels on a parent | OC3 circuits |
| | ring circuit | Ring OC3 linkages peer |
| | OC3 bandwidth (non-channelized) = 155 MB | allowed between ring |
| | OC3 may ride parent OC12 ring | OC3 circuits |
| | and up | Can be a parent in a |
| | OC3 may be channelized to carry 3 | parent/child linkage to: |
| | T3 circuits | Any smaller |
| | OC12 bandwidth (non- | OCx circuit |
| | channelized) = 620 MB | T3 circuits |
| | OC12 may be channelized to carry | T1 circuits (OC3 |
| | 4 OC3s, 12 T3s, or a valid | only) |
| | combination of both | Can be a child in a |
| | OC12 may ride parent OC48 ring | parent/child linkage to: |
| | and up | Any larger OCx |
| | Ring circuits are concentric fiber | circuit |
| | routed circuits with a primary and | Equipment linkages |
| | secondary (in case primary fails) | allowed |
| | route for fault tolerance | No IMA linkages |
| | Ring circuits connect two or more | allowed |
| | locations | |
| | Ring circuits may carry smaller | |
| | ring and point to point circuits | |

### EXAMPLES

The following examples illustrate how linkage rules are used, according to an aspect of the present invention, to track and manage billing and physical link information in an overall end-to-end circuit comprising a plurality of circuit segments. Specifically, each of the examples below illustrates the use of the linkage rules shown in TABLE 1. It should be understood that the present invention is not limited to the embodiments illustrated in the examples.

### Example 1

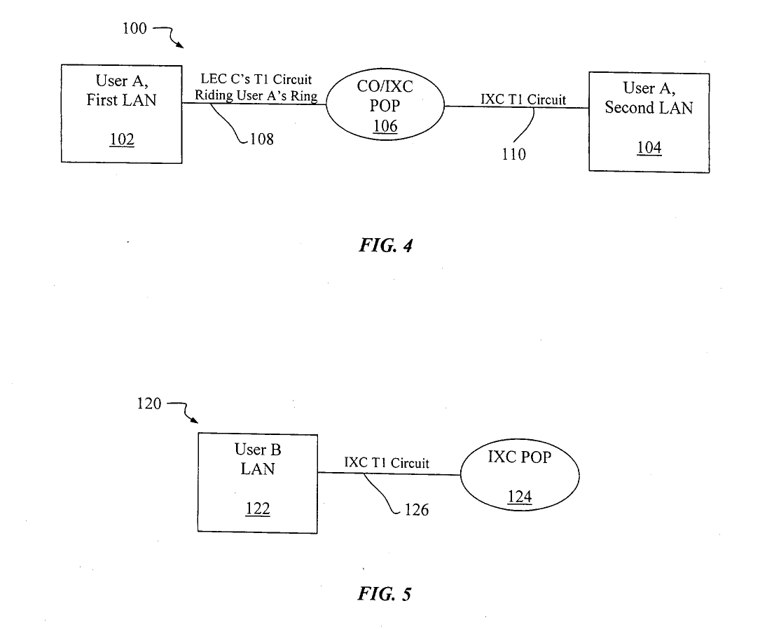

FIG. 4 illustrates a network 100 comprising a first LAN 102 and a second LAN 104 interconnected via circuit segments 108 and 110. The first LAN 102 and the second LAN 104 each represent an internal network infrastructure owned by “user A” at a distinct location. In this example, the first LAN 102 and the second LAN 104 are each located in different cities. Circuit segment 108 comprises a ring circuit (not shown) owned by user A having a T1 circuit owned by “LEC C” riding thereon. LEC C's T1 circuit terminates at IXC's CO POP 106. User A has contracted with the IXC to provide a T1 data circuit 110 for Internet/Intranet connectivity between the first LAN 102 and the second LAN 104. The WXC has also entered into sharing and exchange agreements with “LEC C” for termination in the geographical area of the first LAN 102 and with “LEC D” for termination on its local loop (not shown) in the geographical area of the second LAN 104. For clarity, a POP at the connection between the IXC's T1 circuit 110 and the local loop leased or procured from LEC D by the IXC is not shown.

Since the IXC's T1 circuit 110 is providing the Internet/Intranet connection, it is defined as the primary circuit segment. Thus, as described above, the IXC's T1 circuit 110 has the same logical endpoints as the overall end-to-end circuit at the first LAN 102 and the second LAN 104. LEC C's T1 point-to-point circuit segment 108 (riding user A's ring circuit) is tracked as a secondary circuit segment because it is necessary for user A's support, capacity planning and management activities and because it is riding user A's ring circuit and cannot be leased or procured by the IXC. Since the local loop is leased or procured by the IXC from LEC D, it is not necessary to track LEC D's local loop.

The following information may be entered into a management database, such as the management database 38 shown in FIG. 2, for use by a circuit management system. The IXC's T1 circuit 110 is entered into a circuit table as the primary circuit with endpoints at the first LAN 102 and the second LAN 104. The IXC's T1 circuit 110 is peer linked to LEC C's T1 circuit 108. LEC C's T1 circuit 108 will be entered into the circuit table as a secondary circuit with endpoints at the first LAN 102 and the CO/IXC POP 106. Although not shown, LEC C's T1 circuit 108 is linked to a parent T3 circuit (which in turn rides on the ring circuit) in a parent/child linkage on an appropriate channel. Optionally, LEC D's local loop circuit may also be entered into the circuit table as a secondary circuit with endpoints at the second LAN 104 and another IXC POP (not shown). If LEC D's circuit is thus entered, it is peer linked to the IXC's T1 circuit 110.

### Example 2

FIG. 5 illustrates a network 120 comprising a LAN 122 connected to an IXC POP 124 via a T1 circuit 126 owned by the IXC. In this example, the IXC's T1 circuit 126 is provisioned to provide channelized voice services to “user B.” The network 120 may also comprise a local loop (not shown) leased from “LEC E” by the IXC for termination at the LAN 122.

Since the IXC's T1 circuit 126 is an access circuit configured to provide termination for voice channels, the overall endpoints of the A XC's T1 circuit 126 will be at the IXC's POP 124 and the LAN 122. As a circuit management system may not be configured to track demark information at the IXC's POP 124, the LAN 122 is the only endpoint eligible to maintain demark information. As there may be more than one demark available at the LAN 122, it is necessary to track which demark (i.e., building, floor and room) at user B's physical address the IXC's T1 circuit 126 terminates in. Circuits that contain demark information often terminate to a piece of communication equipment (not shown) located in a particular rack, mounted on a designated shelf, and assigned a port. In this example, a PBX port may be linked to the primary circuit segment 126 via an equipment linkage. Note that multiple pieces of equipment may be linked by equipment linkages. Equipment linkages may be optional, as required by user B.

The following information may be entered into a management database, such as the management database 38 shown in FIG. 2. The IXC's T1 circuit segment 126 is entered into a circuit table as the primary circuit with endpoints at the LAN 122 and the IXC's POP 124. Optionally, LEC E's local loop circuit may also be entered into the circuit table as a secondary circuit with endpoints at the LAN 122 and a second IXC POP (not shown). If LEC E's circuit is thus entered, it is peer linked to the IXC's T1 circuit 126.

### Example 3

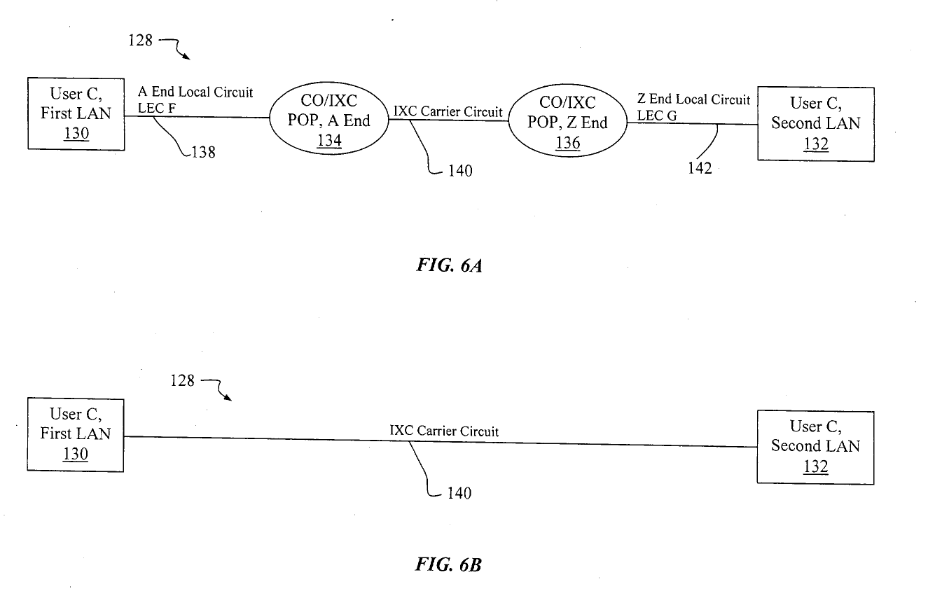

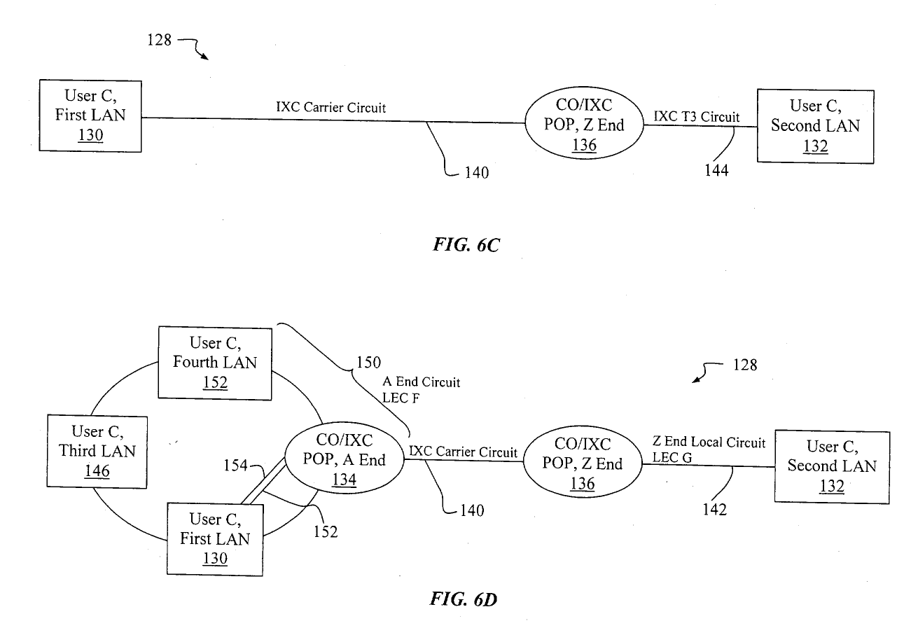

FIG. 6A illustrates a network 128 comprising a first LAN 130 interconnected to a second LAN 132. The first LAN 130 and the second LAN 132 each represent an internal network infrastructure owned by “user C” at a distinct location. In this example, the first LAN 130 is located in a first city (on the “A end”) and the second LAN is located in a second city (on the “Z end”). The network 128 further comprises an IXC point-to-point T1 data circuit 140 between the first city and the second city. A local loop 138 is provided by “LEC F” in the first city. A local loop 142 is provided by “LEC G” in the second city. Neither local loop 138, 142 resides on a private ring or is owned by user B.

The overall network 128 physically has three segments 138, 140, 142. However, since both local circuits 138, 142 do not reside as child circuits on ring circuits or other access equipment owned by user B, the IXC may lease or procure both local circuits 138, 142 and roll up the charges into its own circuit bill under the circuit identifier (hereinafter, “ID”) for the IXC's carrier circuit 140. Therefore, only the IXC's carrier circuit segment 140 needs to be tracked or entered into a management database. However, if tracking the circuit IDs associated with the local circuits 138, 142 is necessary, the local circuits 138, 142 may be entered into the management system as secondary circuits linked in a peer relationship to the IXC's carrier circuit 140.

The following information may be entered into a management database, such as the management database 38 shown in FIG. 2. The IXC's carrier circuit segment 140 is entered into a circuit table as the primary circuit with endpoints at the first LAN 130 and the second LAN 132. Optionally, LEC F's local circuit segment 138 may also be entered into the circuit table as a secondary circuit with endpoints at the first LAN 130 and CO/IXC POP 134. If LEC F's local circuit 138 is thus entered, it is peer linked to the IXC's carrier circuit 140. Further, LEC G's local circuit segment 142 may also be optionally entered into the circuit table as a secondary circuit with endpoints at the second LAN 132 and CO/IXC POP 136. If LEC G's local circuit 142 is thus entered, it is peer linked to the IXC's carrier circuit 140.

FIG. 6B illustrates the network 128 of FIG. 6A modified to show what the circuit management system would track if the local circuits 138, 142 were not entered into the management database.

FIG. 6C illustrates how the network 128 of FIG. 6A would be tracked and managed if the IXC used a pre-existing channelized T3 circuit 144 to terminate the IXC's carrier T1 circuit 140. Segmentation of the network 128 is the same as described above since there is still only one circuit segment, the IXC's carrier circuit 140, at the primary circuit level. However, a parent/child relationship now exists the IXC's carrier circuit 140 (the child) and the IXC's T3 circuit 144 (the parent). Since the parent/child linkage relationship changes the dynamics of the overall network 128, it is necessary to define the topology of the connection and enter the parent/child relationship into the management database.

The following information may be entered into the management database. The IXC's carrier circuit segment 140 is entered into the circuit table as the primary circuit with endpoints at the first LAN 130 and the second LAN 132. If the IXC's T3 circuit 144 does not already exist in the circuit management system, then the IXC's T3 circuit 144 is entered into the circuit table as a primary T3 circuit with endpoints at the second LAN 132 and the CO/IXC POP 136. The IXC's carrier circuit 140 (child) is linked to the IXC's T3 circuit (parent) in a parent/child linkage relationship. Optionally, LEC F's local circuit segment 138 may also be entered into the circuit table as a secondary circuit with endpoints at the first LAN 130 and the CO/IXC POP 134 shown in FIG. A. If LEC F's local circuit 138 is thus entered, it is peer linked to the IXC's carrier circuit 140.

FIG. 6D illustrates how the network 128 of FIG. 6A would be tracked and managed if the IXC's carrier circuit 140 is terminated on a ring circuit 150 in the first city. The ring circuit 150 comprises four nodes at the first LAN 130, a third LAN 146, a fourth LAN 148 and the CO/ IXC POP 134. In this example, the IXC carrier circuit 140 terminates on a child point-to-point T1 circuit 152 riding a parent point-to-point channelized T3 circuit 154 owned by LEC F, which in turn rides on the ring circuit 150 owned by user C. Demark information is only supplied for the endpoint locations of the primary circuit, the IXC's carrier circuit 140. The management system knows that the T1 circuit segment 152 is a secondary circuit linked to the IXC's carrier circuit 140 and shows the overall circuit connection as such.

The management database may be updated by entering the following information. The IXC's carrier circuit segment 140 is entered into the circuit table as the primary circuit with endpoints at the ring circuit 150 and the second LAN 132. The T1 circuit segment 152 is entered into the circuit table as a secondary circuit with endpoints at ring circuit 150 and the CO/IXC POP 134. If LEC F's T3 circuit 154 does not already exist in the circuit management system, then the IXC's T3 circuit 154 is entered into the circuit table as a primary circuit with endpoints at the first LAN 130 and the CO/IXC POP 134. LEC F's T3 circuit 154 (child) is linked to the ring circuit 150 (parent) in a parent/child linkage relationship. Optionally, the T1 circuit segment 152 is entered into the circuit table as a secondary circuit with endpoints at the first LAN 130 and CO/IXC POP 134. If the T1 circuit segment 152 is thus entered, it is peer linked to the IXC's carrier circuit 140.

### Example 4

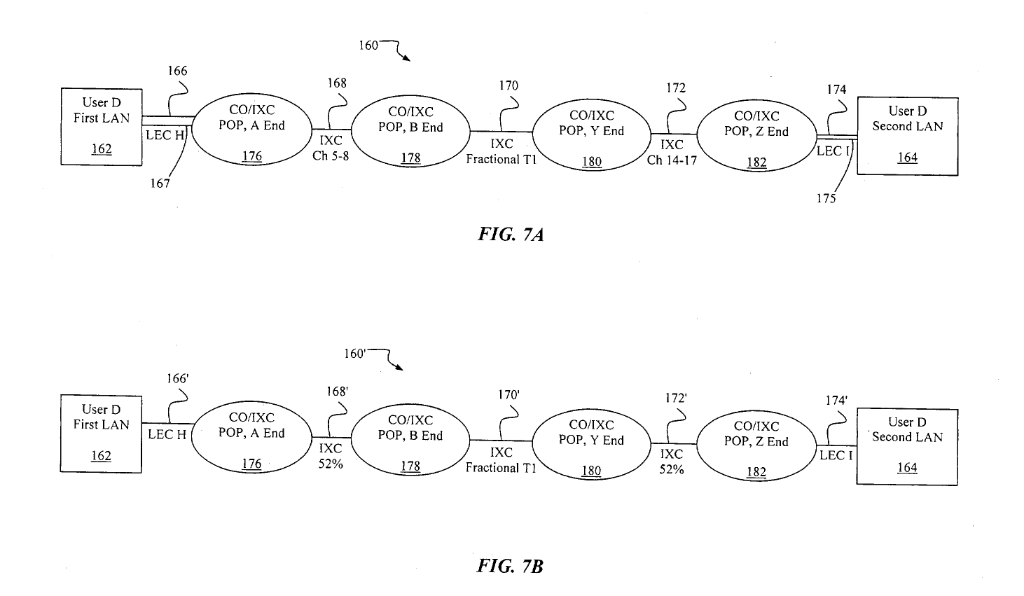

FIG. 7A illustrates a network 160 comprising a first LAN 162 and a second LAN 164 interconnected via a point-to-point 256 KB fractional T1 circuit 170 provided be an IXC. The first LAN 162 and the second LAN 164 each represent an internal network infrastructure owned by “user D” at a distinct location. The IXC's fractional T1 circuit 170 differs from most conventional circuits in that it must use a parent access T1 segment to deliver its payload at each terminating location. Thus, the IXC's fractional T1 circuit 170 interconnects with a channelized T1 access circuit 168 provided by the IXC at a CO/IXC POP 178 at the “B end” and with a channelized T1 access circuit 172 provided by the IXC at a CO/IXC POP 180 at the “Y end.”

Both of the IXC's T1 access circuits 168, 172 are configured to be multiplexed into 24 channels that provide 64 KB of bandwidth per channel. Therefore, the IXC's T1 access circuits 168, 172 may each be configured to provide the required 256 KB of bandwidth by using four contiguous channels. For this example, the IXC's T1 access circuit 168 is configured to use contiguous channels five through eight and the IXC's T1 access circuit 172 is configured to use contiguous channels fourteen through seventeen. Thus, to accurately inventory the network 160, the IXC's fractional T1 circuit 170 is linked as a child on channels five through eight of the IXC's T1 access circuit 168 and as a child on channels fourteen through seventeen of the IXC's T1 access circuit 172. Therefore, the primary segment (i.e., the IXC's fractional T1 circuit 170) is the only segment on its circuit level, but it is using two hierarchically superior primary access circuits (i.e., the IXC's T1 access circuits 168, 172) to deliver its payload.

In this example, both endpoints of the overall network 160 terminate on ring circuits (not shown) provided by “LEC H” at the first LAN 162 and by “LEC I” at the second LAN 164. Thus, the network 160 further comprises a child point-to-point T1 circuit 166 riding a parent point-to-point T3 circuit 167, which in turn rides on LEC H's ring circuit. Also, the network 160 further comprises a child point-to-point T1 circuit 174 riding a parent point-to-point T3 circuit 175, which in turn rides on LEC I's ring circuit.

The following information may be entered into a management database, such as the management database 38 shown in FIG. 2. The IXC's fractional T1 circuit 170 is entered into a circuit table as a primary circuit with endpoints at the first LAN 162 and the second LAN 164. The IXC's T1 access circuit 168 is entered into the circuit table as a primary access circuit with endpoints at the first LAN 162 and the CO/IXC POP 178. The IXC's T1 access circuit 172 is entered into the circuit table as a primary access circuit with endpoints at the second LAN 164 and the CO/IXC POP 180. The IXC's fractional T1 circuit 170 (child) is linked to channel five of the IXC's T1 access circuit 168 (parent) and to channel fourteen of the IXC's T1 access circuit 172 (parent) in a parent/child linkage. Note that the system will determine the number of slots or channels actually used depending on the bandwidth of the IXC's fractional T1 circuit 170.

The T1 circuit 166 is entered into the circuit table as a secondary circuit with endpoints at the first LAN 162 and a CO/IXC POP 176 at the “A end.” The T3 circuit 167 is entered into the circuit table as a primary T3 circuit with endpoints at the first LAN 162 and the CO/IXC POP 176. The T3 circuit 167 (child) is linked to LEC H's ring circuit (parent) in a parent/child linkage. The T1 circuit 166 (child) is linked to the T3 circuit 167 (parent) in a parent/child linkage. The T1 circuit 166 is then peer linked to the IXC's T1 access circuit 168.

The T1 circuit 174 is entered into the circuit table as a secondary circuit with endpoints at the second LAN 164 and a CO/IXC POP 182 at the “Z end.” The T3 circuit 175 is entered into the circuit table as a primary T3 circuit with endpoints at the second LAN 164 and the CO/IXC POP 182. The T3 circuit 175 (child) is linked to LEC I's ring circuit (parent) in a parent/child linkage. The T1 circuit 174 (child) is linked to the T3 circuit 175 (parent) in a parent/child linkage. The T1 circuit 174 is then peer linked to the IXC's T1 access circuit 172.

FIG. 7B illustrates how the network 160 of FIG. 7A would be tracked and managed if the IXC employed a PVC T1 circuit 170′ rather than the fractional T1 circuit 170 shown in FIG. 7A to create an ATM PVC network 160′. In the example shown in FIG. 7B, the IXC employs T3 access circuits 168′ and 172′ rather than the T1 access circuits 168 and 172 shown in FIG. 7A. Further, T3 circuit segments 166′ and 174′ are employed rather than the T1 circuit segments 166 and 174 shown in FIG. 7A.

Generally, fractional circuits are similar to PVC circuits except that PVC circuits do not utilize a channelization scheme. Instead, PVC circuits employ a bandwidth percentage allocation. As shown in FIG. 7B, the IXC's PVC T1 circuit 170′ occupies a percentage of the bandwidth of the IXC's T3 access circuits 168′, 172′ rather than a channel range. In this example, 52% of each of the IXC's T3 access circuits 168′, 172′ is occupied by the IXC's PVC T1 circuit's 170′ bandwidth needs. Note that if the network 160′ had been a frame relay PVC riding T1 access circuits, the only difference with the fractional T1 circuit example shown in FIG. 7A would be that the access circuits 168′, 172′ utilize an unfixed fraction of the bandwidth or Committed Information Rate (or, “CIR”) as opposed to a range of channels.

### Example 5

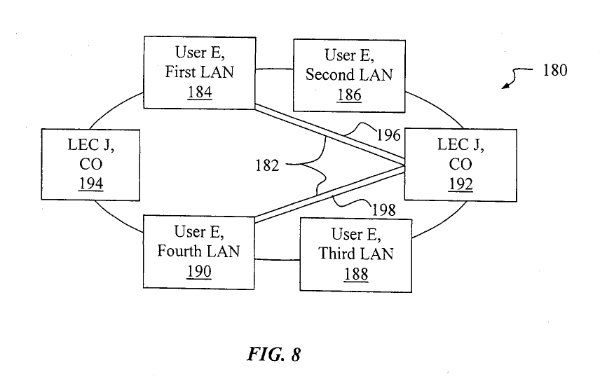

FIG. 8 illustrates a ring circuit 180 owned by “LEC J” and configured to provide interconnectivity between a first LAN 184, a second LAN 186, a third LAN 188, and a fourth LAN 190. Each LAN 184, 186, 188, 190 represents an internal network infrastructure owned by “user E” at a distinct location. The ring circuit 180 further comprises a first CO 192 and a second CO 194, each owned by LEC J. In this example, each LAN 184, 186, 188, 190 and each CO 192, 194 may be located in different cities. For clarity, this example will only discuss tracking and managing an interconnection between the first LAN 184 and the fourth LAN 192 through the first CO 192. However, similar principles may be applied for each possible interconnection in the ring circuit 180.

As shown in FIG. 8, a voice T1 tie trunk 182 riding on two parent channelized T3 circuits 196 and 198 is used to interconnect the first LAN 182 and the fourth LAN 190 without leaving the ring circuit 180. This technique may be used to provide PBX trunking between PBX switches (not shown) at the first LAN 184 and the fourth LAN 190 by utilizing available bandwidth on existing point-to-point T3 circuits 196, 198 riding on the ring circuit 180. Thus, voice calls may be transferred between the PBX switches at the first LAN 184 and the fourth LAN 190 using the T3 circuit 196 between the first LAN 184 and the first CO 192 and the T3 circuit 198 between the first CO 192 and the fourth LAN 190.

While the voice T1 tie trunk 182 rides on two separate parent T3 circuits 196, 198, it is still only one circuit segment between the first LAN 184 and the fourth LAN 190. Therefore, the voice T1 tie trunk 182 may be defined as the primary circuit segment with endpoints at the first LAN 184 and the fourth LAN 190. All linkages are parent/child linkages with the voice T1 tie trunk 182 as a child to the parent T3 circuits 196, 198.

Assuming that the access T3 circuits 196, 198 riding the ring circuit 180 already exist in a management database, such as the management database 38 shown in FIG. 2, the following information may be entered into the database for use by a circuit management system. The voice T1 tie trunk 182 is entered into a circuit table as the primary circuit with endpoints at the first LAN 184 and the fourth LAN 190. The voice T1 tie trunk 182 (child) is linked to the T3 circuit 196 (parent) and to the T3 circuit 198 (parent) on the appropriate channels in a parent/child linkage.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A method for managing communication circuits in a network comprising a first endpoint and a second endpoint, the method comprising:
selecting a primary circuit having a first termination and a second termination;
assigning the first termination to the first endpoint and the second termination to the second endpoint; and
interconnecting the primary circuit to at least one secondary circuit according to predetermined linkage rules.

2. The method of claim 1, wherein interconnecting the primary circuit to the at least one secondary circuit comprises terminating the primary circuit through the at least one secondary circuit.

3. The method of claim 1, further comprising relating the primary circuit and each of the at least one secondary circuit to a circuit type selected from a plurality of circuit types.

4. The method of claim 3, further comprising, for each of the plurality of circuit types, creating the linkage rules by defining permissible circuit linkage relationships for the circuit type.

5. The method of claim 4, wherein defining the permissible circuit linkage relationships comprises selecting a relationship from the group comprising a peer linkage, a parent/child linkage, and a parallel linkage.

6. The method of claim 5, further comprising defining a permissible communication equipment linkage.

7. The method of claim 4, further comprising, for each of the plurality of circuit types, creating the linkage rules by relating the primary circuit to a service category.

8. The method of claim 4, further comprising, for each of the plurality of circuit types, creating the linkage rules by relating the primary circuit and each of the at least one secondary circuit to a topological category.

9. The method of claim 1, further comprising correlating billing and physical link information from each of the at least one secondary circuit with at least the first endpoint.

10. The method of claim 9, further comprising tracking the billing and physical link information selected from a group comprising geographical termination information, demark information, equipment identification information, circuit identification information, order information, trunk group information, and toll free and dial plan information.

11. The method of claim 1, wherein selecting the primary circuit comprises entering a master circuit identifier into a management database.

12. The method of claim 11, wherein assigning the first termination and the second termination comprises:
entering the first termination into the management database as the first endpoint; and
entering the second termination into the management database as the second endpoint.

13. The method of claim 11, further comprising:
entering a third termination corresponding to the at least one secondary circuit into the management database; and
entering a fourth termination corresponding to the at least one secondary circuit into the management database.

14. The method of claim 11, wherein interconnecting the primary circuit to the at least one secondary circuit comprises entering at least one secondary circuit identifier into the management database.

15. A network infrastructure circuit management system comprising:
a processor; and
a computer readable media comprising:
a management database; and
computer executable code for:
selecting a primary circuit from the management database;
selecting at least one secondary circuit from the management database, wherein the at least one secondary circuit is hierarchically linked to the primary circuit;
correlating terminations of the primary circuit with overall network endpoints as defined in the management database; and
cross-correlating the primary circuit and the at least one secondary circuit according to linkage relationships stored in the management database.

16. The system of claim 15, further comprising a circuit segment information means configured to provide selected billing and physical link information from a communication network to the circuit management system.

17. The system of claim 15, wherein selecting the primary circuit comprises selecting a master circuit configured to control service to the overall network endpoints.

18. The system of claim 15, wherein cross-correlating comprises tracking nodes of the at least one secondary circuit to the overall network endpoints as defined by the hierarchically linked relationships.

19. The system of claim 18, wherein the computer executable code is further configured for predefining the allowed linkage relationships for the primary circuit and each of the at least one secondary circuit.

20. The system of claim 15, further comprising:
an input device;
an output device; and
a data storage device.

21. Computer readable media including computer executable instructions for performing:
maintaining circuit identifiers for a plurality of interconnected communication circuits;
managing endpoint location information for each of the plurality of interconnected communication circuits; and
tracking circuit linkage relationships between each of the plurality of interconnected communication circuits.

22. The computer readable media of claim 21, wherein managing endpoint location information comprises tracking a physical address for each endpoint.

23. The computer readable media of claim 22, wherein managing endpoint location information further comprises tracking demark information for at least a portion of the endpoints.

24. The computer readable media of claim 21, wherein tracking circuit linkage relationships comprises maintaining circuit linkages selected from the group comprising a peer linkage, a parent/child linkage and a parallel linkage.

25. The computer readable media of claim 24, further comprising tracking an equipment linkage to a predefined endpoint of a primary circuit selected from the plurality of interconnected communication circuits.

26. The computer readable media of claim 24, further comprising:
selecting at least one circuit from the plurality of interconnected communication circuits corresponding to a dedicated voice trunk group;
mapping the at least one circuit to the voice trunk group; and
linking the voice trunk group to a toll free termination.

27. The computer readable media of claim 26, further comprising linking the voice trunk group to at least one dial plan range.

28. The computer readable media of claim 24, further comprising linking at least one circuit from the plurality of interconnected communication circuits to associated order information.

29. A communication system comprising:
a first network endpoint;
a second network endpoint;
a primary circuit comprising a first physical endpoint and a second physical endpoint, wherein the first physical endpoint is correlated to the first network endpoint and the second physical endpoint is correlated to the second network endpoint; and
a secondary circuit configured to interconnect with the primary circuit according to predetermined linkage rules.
